(19) United States
(12) Patent Application Publication
(10) Pub. No.: US 2014/0175773 A1
(43) Pub. Date: Jun. 26, 2014

(54) FLOW RECTIFIER ASSEMBLY

(71) Applicant: CATERPILLAR INC., Peoria, IL (US)

(72) Inventors: David E. Ault, Peoria, IL (US); Moses I. Akpan, Moline, IL (US); Michael A. Church, El Paso, IL (US); Landin T. Fisher, Raleigh, NC (US)

(73) Assignee: Caterpillar Inc., Peoria, IL (US)

(21) Appl. No.: 13/722,093

(22) Filed: Dec. 20, 2012

(51) Int. Cl. F16L 41/02; B60D 1/24; F16F 9/19

(52) U.S. Cl. CPC F16L 41/02; F16F 9/19; B60D 1/249
USPC 280/446.1; 137/861; 188/314

(57) ABSTRACT

A flow rectifier assembly including a manifold with a variable orifice disposed therein. Further, the flow rectifier assembly includes one or more valves disposed in the manifold and fluidly connected to the variable orifice to provide a uni-directional flow over the variable orifice. Each of the one or more valves includes a poppet. A fly-cut recess defined in the manifold includes a seat for resting the poppet.

### TECHNICAL FIELD

The present disclosure relates to a flow rectifier assembly and more particularly to a flow rectifier assembly including one or more valves.

### BACKGROUND

Machines with two frame portions connected through a hitch assembly such as, for example, a wheel tractor-scraper, a tractor attached by hitch to a planter or other implement, and articulated trucks, are employed in various industries, such as agriculture, construction and mining. The wheel tractor scraper is often used to load, haul, eject and spread layers of earth, and typically includes a tractor portion coupled to a scraper portion by an articulated joint. The scraper portion has a rear frame section that supports a bowl for collecting and hauling material. During such operations, the scraper may transmit mechanical shocks to the tractor portion, including the operator station. These transmitted shocks may cause the operator discomfort.

Wheel tractor scrapers and other hitched or articulated machines may include a suspension system to dampen the transmission of shocks from the one portion of the machine to another portion of the machine through the hitch or articulation joint. Conventionally, the dampening portion of the suspension system includes a fixed orifice. Modern electronics now enable the use of variable orifices to improve the dampening characteristics of the suspension system. These valves may be used in conjunction with other valves which may be installed into a manifold. However, sometimes it may be difficult to install the manifold may in the suspension system because of the space constraints in the machine. Some manifolds may also constrict the flow in the suspension system.

U.S. Pat. No. 7,726,335 discloses a fuel system with a check valve work implement. The check valve work implement includes a valve body, a poppet valve having a valve stem and a valve head adjacent one end of the valve stem. The valve head have a truncated conical portion and a shoulder at the downstream end of the conical portion and integral with the valve head and the entire valve head have the conical portion.

### SUMMARY

In one aspect, the present disclosure provides a flow rectifier assembly including a manifold with a variable orifice disposed therein. Further, the flow rectifier assembly includes one or more valves disposed in the manifold and fluidly connected to the variable orifice to provide a uni-directional flow over the variable orifice. Each of the one or more valves includes a poppet. A fly-cut recess defined in the manifold includes a seat for resting the poppet.

In another aspect, the present disclosure provides a hydraulic suspension system including a hydraulic cylinder assembly. The hydraulic cylinder assembly includes a cylinder and a rod to define a head chamber and rod chamber. The head chamber is fluidly connected to the flow rectifier assembly. Further, one or more accumulators are adapted to selectively receive the pressurized hydraulic fluid from the hydraulic cylinder assembly via the flow rectifier assembly. The flow rectifier assembly including a manifold with a variable orifice disposed therein. Further, the flow rectifier assembly includes one or more valves disposed in the manifold and fluidly connected to the variable orifice to provide a uni-directional flow over the variable orifice. Each of the one or more valves includes a poppet. A fly-cut recess defined in the manifold includes a seat for resting the poppet.

In yet another aspect, the present disclosure provides a hitch assembly for a machine. The hitch assembly is configured to connect a first portion and a second portion of the machine. The hitch assembly includes an articulation hitch to pivotally couple the first portion and the second portion such that the hydraulic suspension system is dampingly connected to the first portion and the second portion. The hydraulic suspension system including a hydraulic cylinder assembly. The hydraulic cylinder assembly includes a cylinder and a rod to define a head chamber and rod chamber. The head chamber is fluidly connected to the flow rectifier assembly. Further, one or more accumulators are adapted to selectively receive the pressurized hydraulic fluid from the hydraulic cylinder assembly via the flow rectifier assembly. The flow rectifier assembly including a manifold with a variable orifice disposed therein. Further, the flow rectifier assembly includes one or more valves disposed in the manifold and fluidly connected to the variable orifice to provide a uni-directional flow over the variable orifice. Each of the one or more valves includes a poppet. A fly-cut recess defined in the manifold includes a seat for resting the poppet.

Other features and aspects of this disclosure will be apparent from the following description and the accompanying drawings.

### BRIEF DESCRIPTION OF THE DRAWINGS

FIG. 1 illustrates a side view of a machine;

FIG. 2 illustrates an enlarged portion of the machine, showing an embodiment of a hitch assembly;

FIG. 3 illustrates a schematic diagram of a suspension system in the hitch assembly of FIG. 2;

FIG. 4 illustrates a perspective view of a flow rectifier assembly;

FIG. 5 illustrates a sectional view of the flow rectifier assembly along a plane X; and

FIG. 6 illustrates a sectional view of a segment of the flow rectifier assembly along a plane Y.

### DETAILED DESCRIPTION

The present disclosure related to a flow rectifier assembly in a hydraulic suspension system. The flow rectifier assembly having a variable orifice disposed in a manifold.

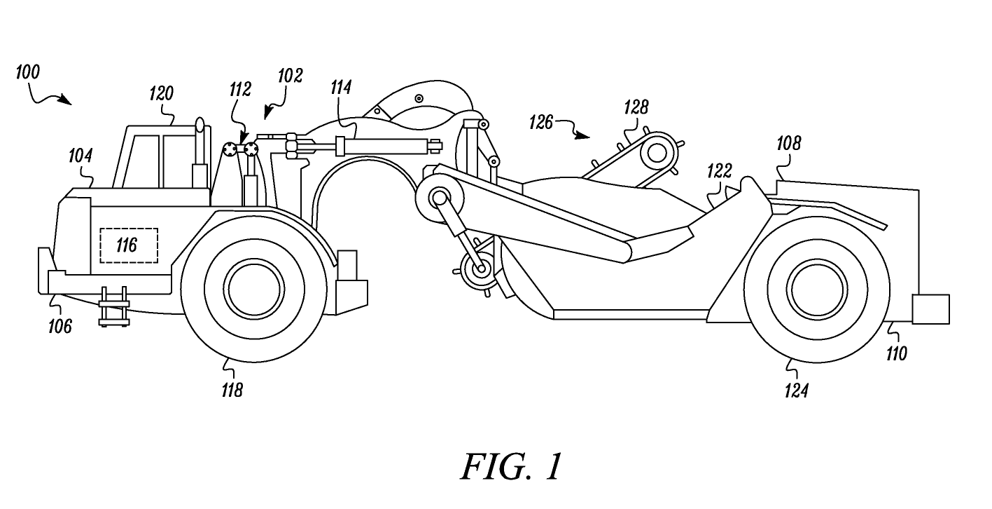

The present disclosure will now be described in detail with reference being made to accompanying drawings. FIG. 1 illustrates a machine 100 having a hitch assembly 102 in which disclosed embodiments of a flow rectifier assembly in an exemplary hydraulic suspension system may be implemented. In the illustrated embodiment, the machine 100 is embodied as a wheel tractor scraper having a first portion 104 (i.e. a tractor portion as a drive vehicle), with a front frame section 106, and a second portion (i.e. a scraper portion 108, either as a drive vehicle or a driven vehicle), with a rear frame section 110. The tractor portion 104 and the scraper portion 108 are pivotally coupled at the hitch assembly 102 via an articulation hitch 112. During operation, steering may be provided by one or more steering actuators 114 (only one side is shown) mounted between the tractor portion 104 and the scraper portion 108 on opposite sides of the machine 100.

The front frame section 106 supports a power source 116 and a cooling system (not shown). The power source 116 is operatively connected through a transmission (not shown) to drive front wheels 118 located on opposite sides of the machine 100. The front frame section 106 may also support an operator station 120 for primary control of the machine 100 during operation. The rear frame section 110 supports a bowl 122 on rear wheels 124. The bowl 122 may also include a work implement 126, such as a conveyor 128. In other embodiments, the bowl 122 may include an auger, an elevator, and/or a spade, to facilitate penetration, loading, and/or unloading of material to be transported by the machine 100.

The power source 116 may be an internal combustion engine like a gasoline, diesel or natural gas engine, etc. The power source 116 may alternatively include a non-combustion source of power such as a fuel cell, a power storage device like a battery, an overhead conductor, or other similar devices. In an alternative embodiment, the machine 100 may include a hydraulic drive or an electric drive. For example, the power source 116 may be operatively connected to a pump, such as a variable or fixed displacement hydraulic pump to produce a pressurized fluid directed to one or more hydraulic motors associated with the front wheels 118. Alternatively, the power source 116 may be drivably connected to an alternator or generator configured to produce an electrical current used to power one or more electric motors for driving the front wheels 118 and/or the rear wheels 124. In addition to driving the front wheels 118, the power source 116 may be configured to supply power to the work implement 126 to penetrate and/or transfer material into or out of the bowl 122, or to perform other operations.

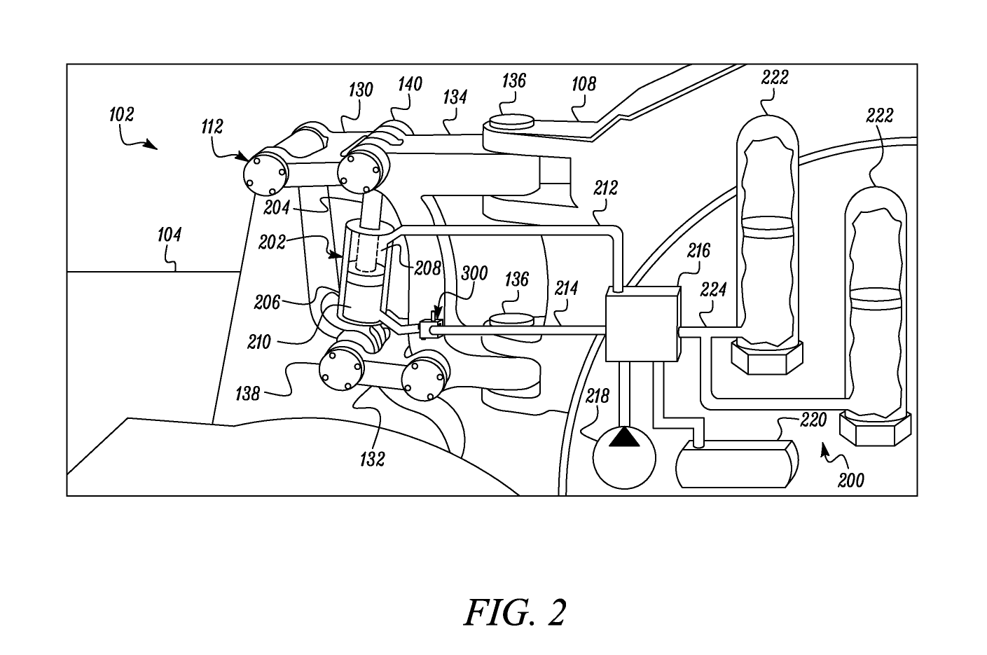

FIG. 2 illustrates a portion of the machine 100 of FIG. 1, showing a schematic of the articulation hitch 112. The articulation hitch 112 includes a hydraulic suspension system 200 dampingly connected to the tractor portion 104 and the scraper portion 108. As illustrated in FIG. 2, the tractor portion 104 is coupled to the scraper portion 108 of the machine 100 via a first and a second pivotable links 130, 132. In an embodiment, the articulation hitch 112 includes a yoke member 134 to couple the first and the second pivotable links 130, 132 to the scraper portion 108 using one or more vertical pivot pins 136.

The hydraulic suspension system 200 may be a closed-loop hydraulic system including a hydraulic cylinder assembly 202, having an extendable rod 204, and disposed between and coupled to the first pivotable link 130. A body portion 206 of the hydraulic cylinder assembly 202 coupled with the second pivotable link 132. For example, the body 206 and the rod 204 attached to a tractor portion pivot 138 and a scraper portion pivot 140, respectively. However, it should be understood that the orientation of hydraulic cylinder assembly 202 may be inverted and/or switched as long as the first and the second pivotable links 130, 132 are configured to pivot between the tractor portion 104 and the scraper portion 108.

The body 206 of the hydraulic cylinder assembly may define a rod chamber 208 and a head chamber 210 provided with respective hydraulic lines 212, 214 to selectively receive a pressurized hydraulic fluid and cause retraction or extension of the rod 204. The extension and retraction of the rod 204 adjusts a relative height of the tractor portion 104 in relation to the scraper portion 108 on an uneven ground due to the pivoting of the first and second pivotable links 130, 132. The flow of the pressurized hydraulic fluid may be controlled by a leveling valve 216. The leveling valve 216 is configured to selectively receive the pressurized fluid from a fluid pump 218 that is powered by power source 116 or by some other power source and return the fluid to a holding tank 220 during the extension and retraction of the rod 204. The leveling valve 216 may also lock the rod 204 into a fully retracted position, a fully extended position, and/or at any position in between during operation of the machine 100.

Further, one or more accumulators 222 are fluidly coupled with the leveling valve 216 via an accumulator hydraulic line 224. The accumulator 222 may be a fluid tank having a free-floating piston, bladder, or other device that divides the accumulator 222 into different chambers. One chamber is for the pressurized fluid and one chamber is for a compressible gas (e.g., nitrogen). The accumulator 222 receives the pressurized fluid in a fluid chamber, which displaces the piston or bladder, thus compressing the gas in the gas chamber. Accordingly, the accumulator 222 provides compliance to the pressurized fluid.

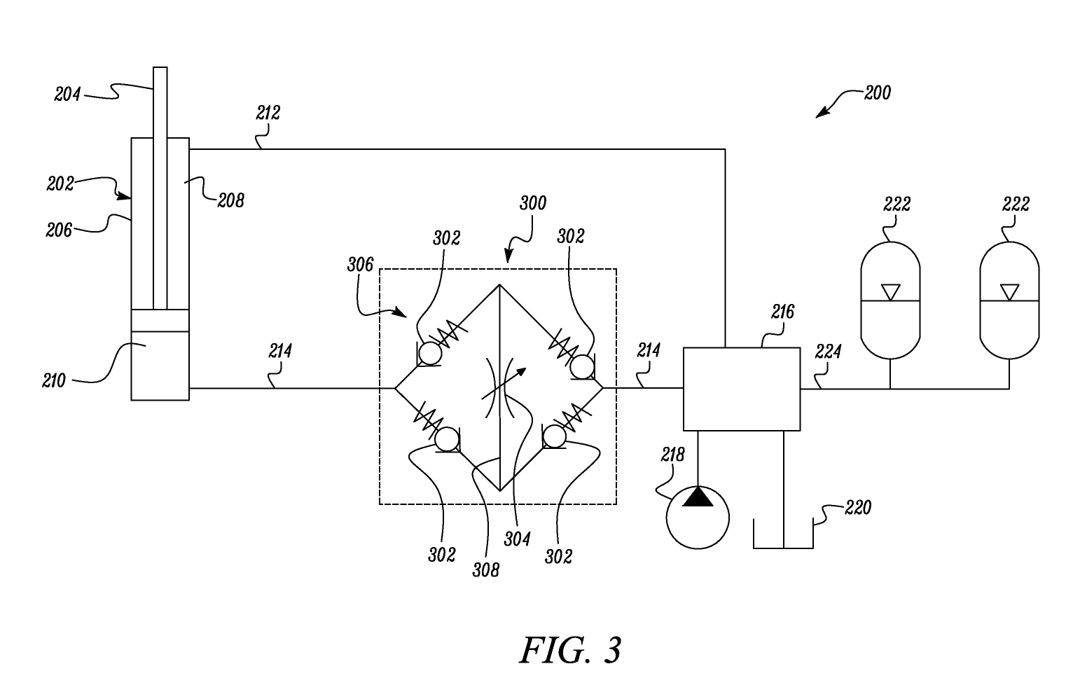

According to an embodiment of the present disclosure, as will be explained in more detail below, the head chamber 210 is fluidly connected with a flow rectifier assembly 300 to influence a speed at of the rod 204 during the extension and retraction. FIG. 3 illustrates a schematic diagram of a hydraulic fluid circuit associated with the hydraulic suspension system 200 of FIG. 2. The flow rectifier assembly 300 may include one or more valves 302 and a variable orifice 304 disposed within. The one or more valves 302 may be arranged in a particular manner to provide a uni-directional flow of the hydraulic fluid through the variable orifice 304. In an embodiment, the one or more valves 302 may be arranged in a bridge circuit 306, as illustrated in FIG. 3. In a particular configuration, the flow rectifier assembly 300 may include four valves 302 arranged in the bridge circuit 306 with the variable orifice 304 disposed in an auxiliary branch 308 of the bridge circuit 306.

Further, in an embodiment, the flow rectifier assembly 300 may include two or more variable orifices 304 arranged in parallel to control the flow of the hydraulic fluid. The variable orifice 304 may be mechanically, hydraulically or electrically controlled by means of a controller (not shown). The controller may be pre-programmed to control the restriction of the variable orifice 304 by any means known in the art. These means may include mechanical, hydraulic, or electrical means. Further, the valves 302 of the may be check valves allowing the flow of the hydraulic fluid in one direction to guarantee the uni-directional flow of the hydraulic fluid through the variable orifice 304 during the flow of the hydraulic fluid from the accumulators 222 to the hydraulic cylinder assembly 202 and vice-versa.

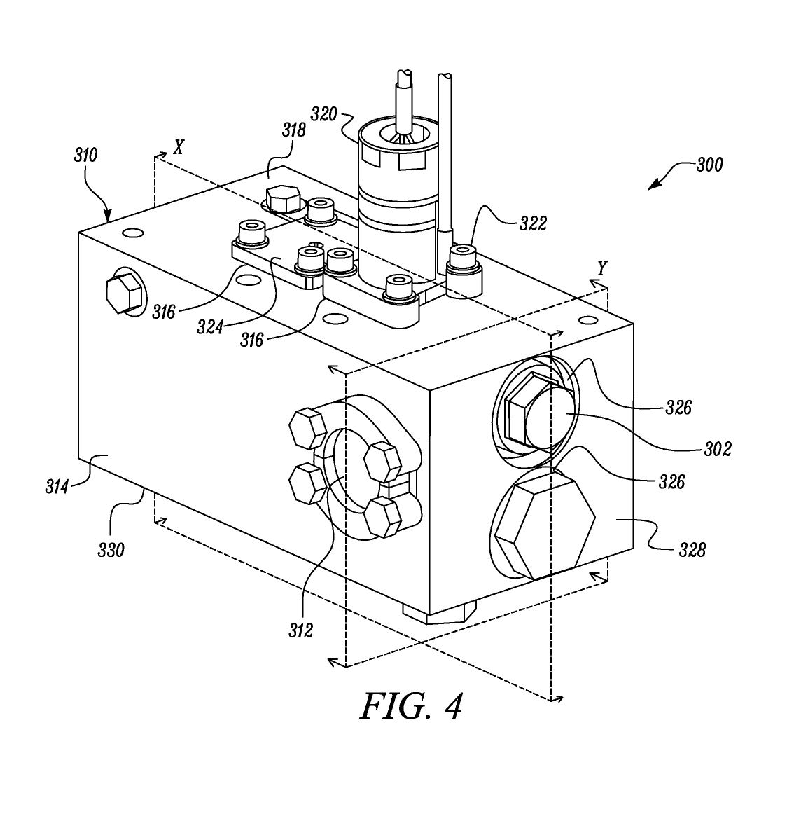

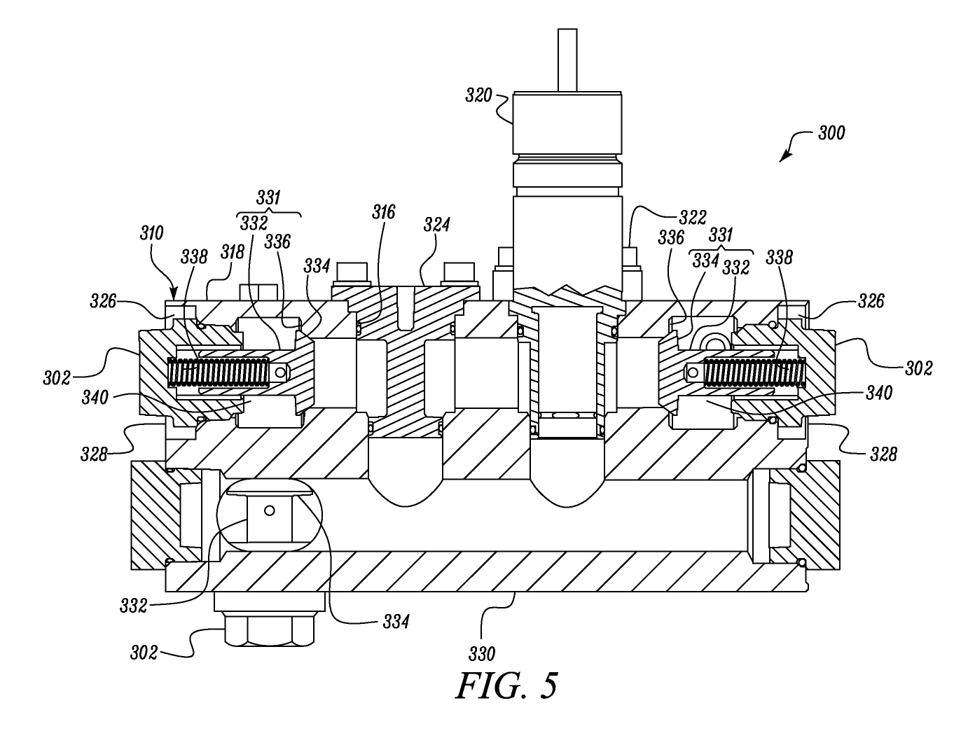

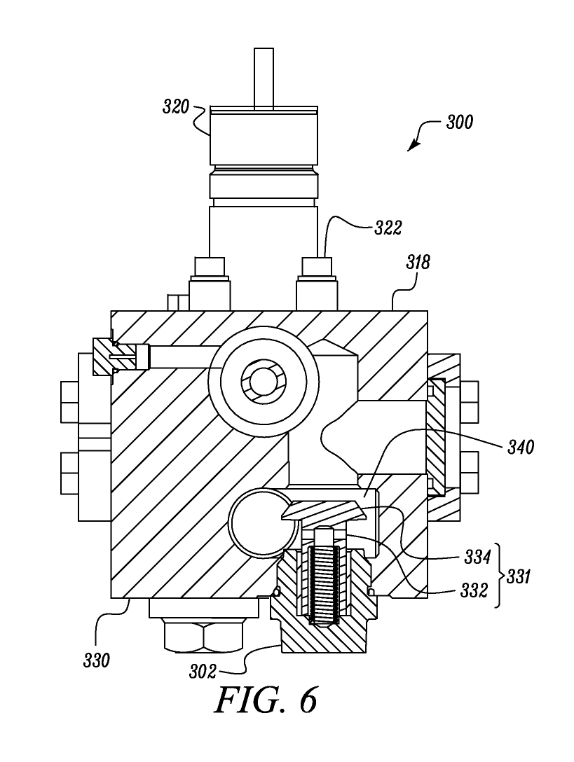

FIGS. 4-6 illustrate different views of the flow rectifier assembly 300, according to an embodiment of the present disclosure. Specifically, FIG. 4 illustrates a perspective view of the flow rectifier assembly 300. Further, FIGS. 5 and 6 illustrate sectional views of the flow rectifier assembly 300, of FIG. 4, along planes X and Y, respectively. As illustrated in FIG. 4, the flow rectifier assembly 300 may include a manifold 310 may be of any shape suitable to the application and the space constraints in the machine 100. In an embodiment, the manifold 310 is in the shape of a block adapted to accommodate the various components, for example, the variable orifice 304 and the valves 302 fluidly connected to the variable orifice 304. Further, in an exemplary embodiment, the manifold 310 may be made of the material like steel, aluminum, cast iron or the like.

In an embodiment, the manifold 310 may include intake ports 312 provided on opposite faces 314 (only one is shown) to connect with the hydraulic line 214 disposed between the head chamber 210 of the hydraulic cylinder assembly 202 and the leveling valve 216. Further, one or more shock valve ports 316 may be provided on a top face 318 of the manifold 310 wherein shock valves 320 having the variable orifice 304 may be secured using mechanical fasteners 322. In the illustrated embodiment, one of the shock valve ports 316 is closed using a port plug 324 and may be utilized to connect another shock valves 320 based on the requirement of the hydraulic system 200. Furthermore, valve ports 326 may be provided to accommodate the valves 302 on lateral faces 328 and a bottom face 330 of the manifold 310.

Referring now to FIG. 5, the valve 302 may include a poppet 331 divided into a stem portion 332 and a head portion 334. The head portion 334 may be mushroom-shaped disposed on the stem portion 332. According to an embodiment of the present disclosure, a fly-cut recess 340 defined in the manifold 310. The fly-cut recess 340 includes a seat 336 for resting the head portion 334 of the poppet 331 against the seat 336. The valves 302 include a spring 338 biasing the poppet to rest against the seat 336. In an exemplary embodiment, the stem portion 332, in the form of a plunger, may be loaded with the spring 338 to bias the head portion 334 of the poppet 331 against the seat 336. Alternatively, the stem portion 332 may be magnetically actuated to linearly move in the valve port 326. The fly-cut recess 340 may be carved out of the manifold 310 by removing a portion of a fluid passage in the bridge circuit 306 in the manifold 310 and forming the seat 336 using some tools. Alternatively, the fly-cut recess 340 may be pre-formed with the seat 336 during manufacturing of the manifold 310. Thus, the valve 302 of the present disclosure may be considered to have a fly-cut profile. The fly-cut recess 340 may result in a larger area for the head portion 334 to rest on the seat 336. Specifically, the fly-cut recess 340 may provide more space for positioning the head portion 334 in the valve 302 and while allowing the required flow of the hydraulic fluid.

Referring now to FIG. 6, the shape and the size of the fly-cut recess 340 may define the pressure drop of the hydraulic fluid in the hydraulic suspension system 200 and/or the size of the manifold 310. In an embodiment, the fly-cut recess 340 may be in the shape of a circular indent. Further, the fly-cut recess 340 may have a diameter in the range of about 40-60 millimeters. However, it should be understood, that the shape and size of the fly-cut recess 340 may vary according to the seat 336 in the manifold 310, which in turn may be dependent on the space constraints for the articulation hitch 112 in the machine 100.

### INDUSTRIAL APPLICABILITY

The industrial applicability of a flow rectifier manifold with a fly-cut recess will be readily appreciated from the foregoing discussion. The flow rectifier manifold may be utilized in any off-highway machine with two frame portions connected through a hitch assembly such as, for example, a wheel tractor-scraper, a tractor attached by hitch to a planter or other implement, and articulated trucks, which are employed in various industries, such as agriculture, construction, earth moving operations like loading, hauling, and moving of material from one location to another location.

The machine 100 may be employed in push-pull operations, wherein the scraper portion 108 is either pulled or pushed by a second machine, for example, a track-type dozer or another wheel tractor-scraper, during the loading process. The machine 100 is often provided with push bars (not illustrated) to facilitate such operation. Some machines (e.g., twin-engine scrapers) may also be provided with an additional, rear mounted engine or other secondary propulsion power source system operatively connected to drive the scraper portion 108, making these machines better suited for handling adverse terrain and worksite conditions. Other alternatives provide a fluid operated drive assist system for the scraper portion 108 in the machine 100.

During operation of the machine 100, the work implement 126 is typically lowered to engage with the ground along a cutting edge that is driven forward by the machine 100, thus, scraping the earth and loading the bowl 122. The earth-moving work implement 126, such as the blade, elevator, conveyor, auger, or spade, associated with the bowl 122 facilitates penetration, loading, and/or unloading of the material to be transported.

During this process, some vibrations or shocks may be produced from the ground and the work implement 126 in the scraper portion 108. These shocks may be transferred from the scraper portion 108 to the tractor portion 104 in the machine 100. This may cause uncomfort to the operator in the operator station 120 disposed in the front frame section 106.

The articulation hitch 112 of the present disclosure may be configured as a cushion hitch to reduce the shock transfer from the scraper portion 108 and the ground to the tractor portion 104. The articulation hitch 112 may provide pivoting between the scraper portion 108 and the tractor portion 104 via the pivotable links 130, 132 to pivot and dampen-off the shocks. Thus, the articulation hitch 112 greatly reduces shock and vibration being transferred to an operator in the operator station 120 of the machine 100.

The hydraulic suspension system 200 may absorb the shocks through the hydraulic cylinder assembly 202 coupled between the tractor portion 104 and the scraper portion 108. The hydraulic suspension system 200 permits the rod 204 to retract and provide a flow of the hydraulic fluid from the hydraulic cylinder assembly 202 to the accumulator 222 via the flow rectifier assembly 300. The accumulator 222 may absorb and store energy as hydraulic energy due to the shocks. In the flow rectifier assembly 300, the hydraulic fluid may pass over the variable orifice 304 which may be regulated via a controller to create restriction in the flow of the hydraulic fluid to cause a controlled pressure drop and thus to reduce a bounce back in the hydraulic cylinder assembly 202 due to the flow of the hydraulic fluid. The valves 302 in the flow rectifier assembly 300 may selectively allow the hydraulic fluid to pass through by opening and closing.

For better regulation of the flow of the hydraulic fluid in the hydraulic circuit associated with hydraulic suspension system 200, the fly-cut recess 340 of the present disclosure may be provided in the manifold 310 for the seat 336 of the valve 302. The fly-cut recess 340 may allow and increase area for the flow with lesser restrictions to lower pressure drop about the valves 302 in the flow rectifier assembly 300. Further, lowering the unwanted pressure drop about the valves 302 may save some pressure energy of the hydraulic fluid in the hydraulic circuit and thus result in more efficient hydraulic suspension system 200 in the articulation hitch 112.

In addition to this, the fly-cut recess 340 defined in the seat 336 may allow for a shorter stroke length for the stem portion 332 of the valve 302 in the manifold 310. This allows for a more compact shape for the manifold 310 in the flow rectifier assembly 300. Further, this may provide possibilities for the manifold 310 of the present disclosure to be used in machines with space constraints for the flow rectifier assembly 300 to be utilized in the hydraulic suspension system 200.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

1. A flow rectifier assembly comprising:
a manifold connected with a hydraulic line and a hydraulic cylinder assembly;
a variable orifice disposed in the manifold;
one or more valves disposed in the manifold, the one or more valves fluidly connected to the variable orifice and arranged to provide a uni-directional flow of hydraulic fluid through the variable orifice to and from the hydraulic cylinder assembly, at least one of the one or more valves including a poppet; and
a fly-cut recess defined in the manifold, the fly-cut recess including a seat for resting the poppet.

2. The flow rectifier assembly of claim 1, wherein the manifold is in the shape of a block.

3. The flow rectifier assembly of claim 1, wherein the manifold is made of any of steel, aluminum or cast iron.

4. The flow rectifier assembly of claim 1, wherein at least one of the one or more valves includes a check valve.

5. The flow rectifier assembly of claim 1, wherein the one or more valves includes four valves.

6. The flow rectifier assembly of claim 1, wherein the one or more valves are fluidly connected with the variable orifice in a bridge circuit.

7. The flow rectifier assembly of claim 1, wherein at least one of the one or more valves includes a spring biasing the poppet to rest against the seat.

8. The flow rectifier assembly of claim 1, wherein the poppet includes a stem portion and a head portion, and wherein the head portion is adapted to rest on the seat.

9. The flow rectifier assembly of claim 1, wherein the fly-cut recess is formed in the manifold by cutting out a portion of a fluid passage.

10. The flow rectifier assembly of claim 1, wherein the fly-cut recess includes a circular shape.

11. The flow rectifier assembly of claim 1, wherein the diameter of the fly-cut recess is in the range of 40-60 millimeters.

12. A hydraulic suspension system comprising:
a flow rectifier assembly including,
a manifold,
a variable orifice disposed in the manifold,
one or more valves disposed in the manifold, fluidly connected to the variable orifice, and arranged to provide a uni-directional flow over the variable orifice, at least one of the one or more valves including a poppet, and
a fly-cut recess defined in the manifold, the fly-cut recess including a seat for resting the poppet;
a hydraulic cylinder assembly including a cylinder and a rod defining a head chamber and a rod chamber, the head chamber fluidly connected with the flow rectifier assembly; and
one or more accumulators selectively fluidly connected with the flow rectifier assembly.

13. The hydraulic suspension system of claim 12, further including a fluid pump selectively fluidly connected with the flow rectifier assembly and at least one of the one or more accumulators.

14. The hydraulic suspension system of claim 13 further including a leveling valve fluidly connected with the flow rectifier assembly, the fluid pump, and at least one of the one or more accumulators.

15. The hydraulic suspension system of claim 12, wherein the one or more valves includes four valves arranged in a bridge circuit.

16. The hydraulic suspension system of claim 12, wherein the fly-cut recess is formed in the manifold by cutting out a portion of a fluid passage.

17. The hydraulic suspension system of claim 12, wherein the fly-cut recess is circular in shape.

18. A hitch assembly for a machine, the hitch assembly configured to connect a first portion and a second portion of the machine, the hitch assembly comprising:
an articulation hitch configured to pivotally couple the first portion and the second portion; and
a hydraulic suspension system dampingly connected to the first portion and the second portion, the hydraulic suspension system including,
a flow rectifier assembly including,
a manifold,
a variable orifice disposed in the manifold,
one or more valves disposed in the manifold, fluidly connected to the variable orifice, and arranged to provide a uni-directional flow over the variable orifice, at least one of the one or more valves including a poppet, and
a fly-cut recess defined in the manifold, the fly-cut recess including a seat for resting the poppet,
a hydraulic cylinder assembly including a cylinder and a rod defining a head chamber and a rod chamber, the head chamber fluidly connected with the flow rectifier assembly, and
one or more accumulators selectively fluidly connected with the flow rectifier assembly.

19. The hitch assembly of claim 18, wherein the fly-cut recess is formed in the manifold by cutting out a portion of a fluid passage.

20. The hitch assembly of claim 18, wherein the fly-cut recess is circular in shape.

21. A flow rectifier assembly comprising:
a manifold;
a variable orifice disposed in the manifold;
one or more valves disposed in the manifold, fluidly connected to the variable orifice, and arranged to provide a uni-directional flow over the variable orifice, at least one of the one or more valves including a poppet;
a fly-cut recess defined in the manifold, the fly-cut recess including a seat for resting the poppet; and
wherein the one or more valves are fluidly connected with the variable orifice in a bridge circuit.
